(19) United States
(12) Patent Application Publication
(10) Pub. No.: US 2015/0311048 A1
(43) Pub. Date: Oct. 29, 2015

(54) MICRO HYBRID DIFFERENTIAL/TRIODE ION PUMP

(71) Applicant: Honeywell International Inc., Morristown, NJ (US)

(72) Inventors: Karl D. Nelson, Plymouth, MN (US); Steven Tin, Plymouth, MN (US)

(21) Appl. No.: 14/448,411

(22) Filed: Jul. 31, 2014

Related U.S. Application Data
(60) Provisional application No. 61/983,750, filed on Apr. 24, 2014.

(51) Int. Cl. H01J 41/18; F04B 53/16; F04B 37/14; F04B 19/00; F04B 35/04

(52) U.S. Cl. CPC H01J 41/18; F04B 19/006; F04B 35/04; F04B 37/14; F04B 53/16

(57) ABSTRACT

An ion pump includes at least one electron source configured to emit electrons into the ion pump; at least one cathode positioned across the ion pump from the at least one electron source; a high-voltage grid positioned between the at least one electron source and the at least one cathode. The high-voltage grid is configured to draw the electrons in between the at least one electron source and the at least one cathode where the electrons collide with gas molecules causing the gas molecules to ionize. The at least one cathode is configured to draw ionized gas molecules toward the at least one cathode such that the ionized gas molecules are trapped by or near the at least one cathode.

### PRIORITY/BENEFIT CLAIM

This patent application claims the benefit of U.S. Provisional Patent Application No. 61/983,750, entitled “MICRO HYBRID DIFFERENTIAL/TRIODE ION PUMP” filed Apr. 24, 2014, which is hereby incorporated herein by reference.

### INCORPORATION BY REFERENCE OF RELATED APPLICATIONS

This patent application is related to the following:

U.S. Provisional Patent Application No. 61/943,778, entitled “THIN FILM EDGE FIELD EMITTER BASED MICRO ION PUMP” filed Feb. 24, 2014, which is hereby incorporated herein by reference; and

U.S. patent application Ser. No. 14/277,309, entitled “THIN FILM EDGE FIELD EMITTER BASED MICRO ION PUMP” filed May 14, 2014, which is hereby incorporated herein by reference.

### BACKGROUND

Cold atom sensors use low pressure/ultra-high vacuum (UHV) in small packages. Maintaining ultra-high vacuum by eliminating leaks is difficult. Pumps are often used in order to maintain ultra-high vacuum for the lifespan of a sensor. Some existing pumps are greater than 10 cubic centimeters in volume, which is larger than the entire volume of some sensors. Some existing pumps use Penning traps, which use strong magnetic fields to trap electrons. Magnetic fields can interfere with cold-atom sensors.

### SUMMARY

An ion pump includes at least one electron source configured to emit electrons into the ion pump; at least one cathode positioned across the ion pump from the at least one electron source; a high-voltage grid positioned between the at least one electron source and the at least one cathode. The high-voltage grid is configured to draw the electrons in between the at least one electron source and the at least one cathode where the electrons collide with gas molecules causing the gas molecules to ionize. The at least one cathode is configured to draw ionized gas molecules toward the at least one cathode such that the ionized gas molecules are trapped by or near the at least one cathode.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a cross sectional perspective view diagram of an exemplary ion pump.

FIG. 2A is a cross sectional top view diagram of the exemplary ion pump of FIG. 1.

FIG. 2B is a cross sectional top view diagram of another exemplary ion pump.

FIG. 2C is a cross sectional top view diagram of another exemplary ion pump.

FIG. 2D is a cross sectional top view diagram of another exemplary ion pump.

FIG. 3 is a cross sectional top view diagram of another exemplary ion pump.

FIG. 4 is a cross sectional top view diagram of another exemplary ion pump.

FIG. 5 is a flow diagram of an example method of manufacturing an exemplary ion pump.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

Exemplary ion pumps (and more specifically, micro hybrid differential/triode ion pumps) described herein have volumes less than 1 cubic centimeter and require no magnetic field. Exemplary ion pumps are optimized for pumping noble gases as other gases can be pumped with getter materials. Exemplary ion pumps have the benefits of both differential ion pumps and triode ion pumps in a small volume.

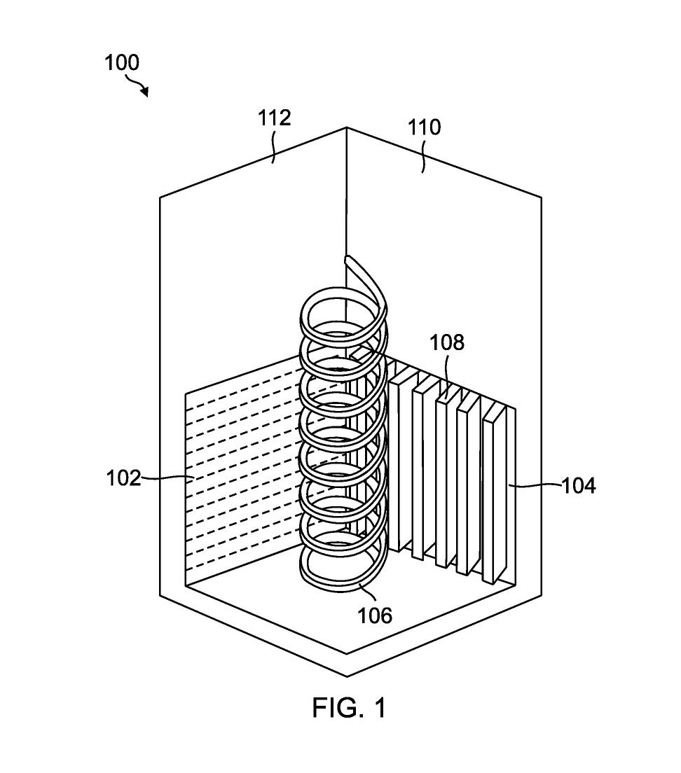

FIG. 1 is a block diagram of an exemplary ion pump 100. Exemplary ion pump 100 includes at least one electron source 102, at least one cathode 104, a high-voltage (static potential) grid 106 positioned between the at least one electron source 102 and the at least one cathode 104, and an optional Titanium (Ti) array 108 positioned between the at least one cathode 104 and the high-voltage grid 106.

In exemplary embodiments, the at least one electron source 102 includes a plurality of electron sources 102. In exemplary implementations, the plurality of electron sources 102 are parallel with each other on a first plane. In other exemplary implementations, a first portion of the plurality of electron sources 102 are on the first plane and a second portion of the plurality of electron sources 102 are on a second plane. In exemplary implementations, the second plane is perpendicular to the first plane. In exemplary implementations, at least one of the first plane and the second plane are approximately 1 centimeter square in surface area. In exemplary embodiments, the at least one electron source 102 includes field emitter arrays. In exemplary implementations, the field emitter arrays are massively parallel field emitter arrays that implement field emission. In exemplary embodiments, the at least one electron source 102 includes edge emitters that generate sufficient electron current such that enough gas molecules are ionized even without the enhancement enabled by a Penning trap. In exemplary embodiments, the at least one electron source 102 includes any combination of edge emitters, sharp tips, beta emitters, and/or thermal electron emitters. Edge emitters are less susceptible to burn-out than sharp tips and are protected from ion bombardment by a “gate” layer.

In exemplary embodiments, the at least one cathode 104 includes a plurality of cathodes 104. In exemplary implementations, the plurality of cathodes 104 are parallel with each other on third plane. In other exemplary implementations, a first portion of the plurality of cathodes 104 are on the third plane and a second portion of the plurality of cathodes 104 are on a fourth plane. In exemplary implementations, the fourth plane is perpendicular to the third plane. In exemplary implementations, the third plane is perpendicular to the second plane. In exemplary implementations, the fourth plane is perpendicular to the first plane. In exemplary implementations, at least one of the third plane and the fourth plane are approximately 1 centimeter square in surface area. In exemplary implementations, the at least one cathode 104 is part of a pump wall 110. In exemplary embodiments, the cathode is made of stainless steel.

In exemplary embodiments including the optional Titanium array 108, the optional Titanium array 108 includes Titanium protrusions positioned on the third (and/or fourth) plane of the at least one cathode 104. In exemplary embodiments, the at least one cathode 104 is part of a pump wall 110 of the ion pump 100 and the optional Titanium array 108 is a coating over portions of the cathode. In exemplary embodiments, the at least one cathode 104 is part of a pump wall 110 of the ion pump 100 and the optional Titanium array 108 is positioned on the cathode. In exemplary implementations where the at least one cathode 104 is part of a pump wall 110 of the ion pump 100 and the optional Titanium array 108 is positioned on the pump wall 110 and/or a coating on portions of the cathode, the optional Titanium array 108 includes protrusions away from the cathode. In exemplary implementations, these protrusions are perpendicular to the cathode.

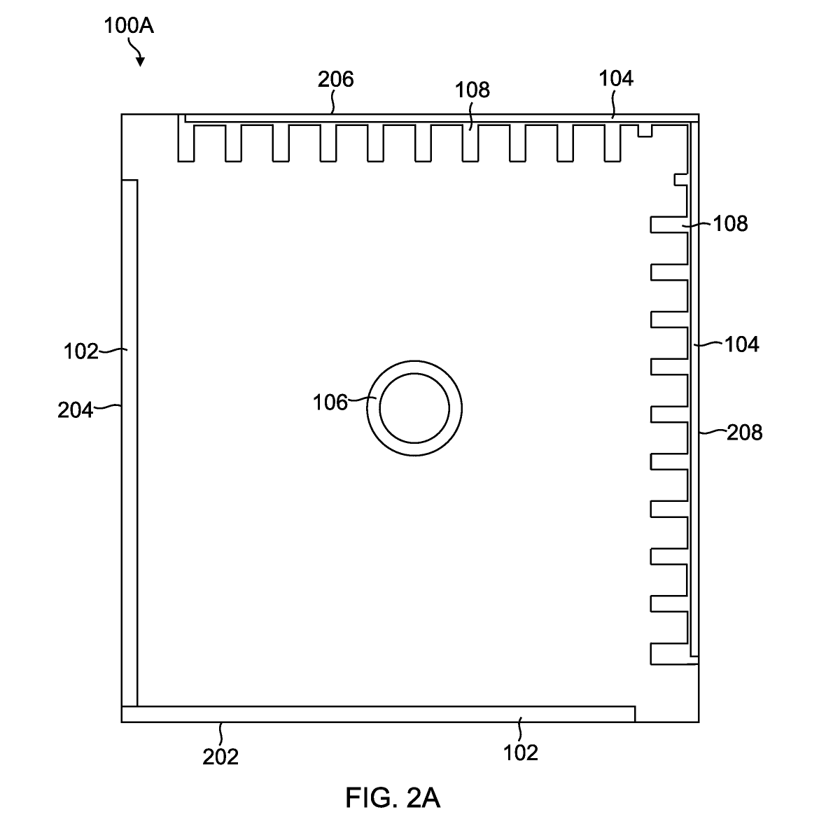

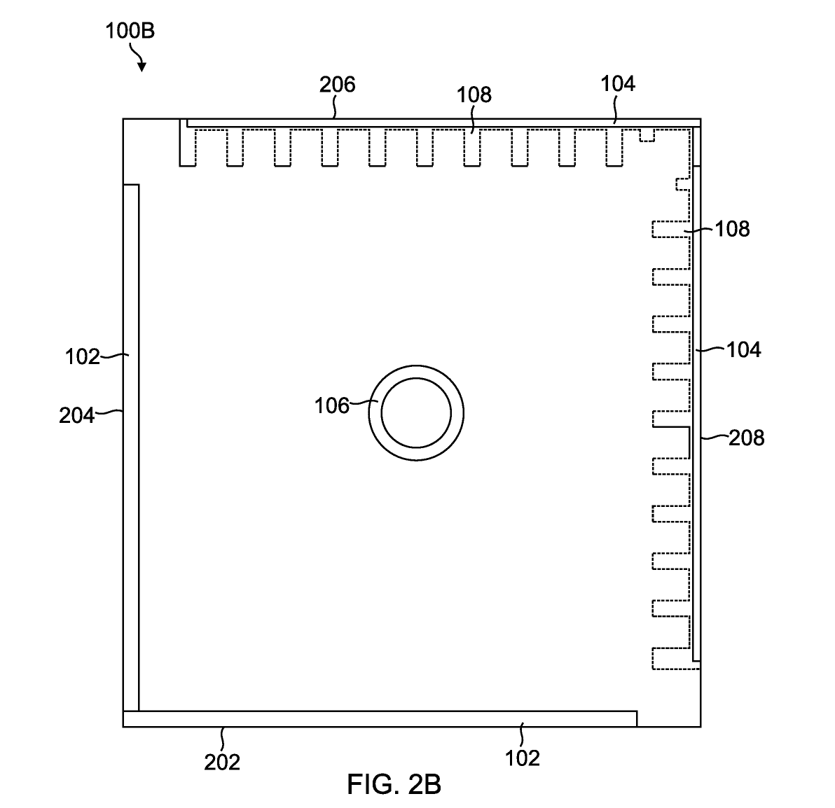

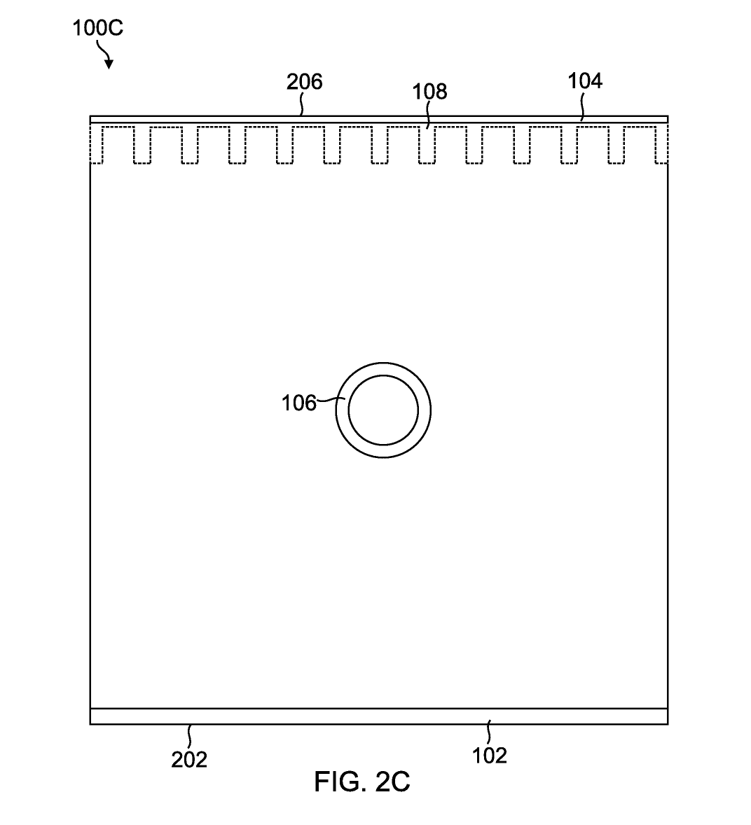

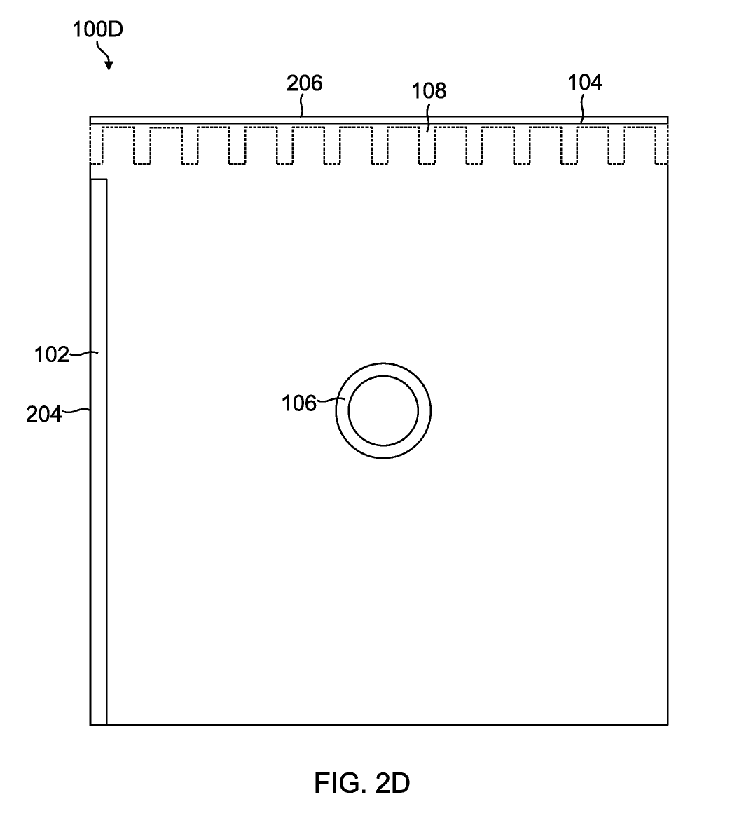

In exemplary embodiments (such as the embodiments shown in FIGS. 2A-2B), two planes of electron sources 102 (such as electron emitters including field emitters and associated gates) are fabricated and connected at right angles and two planes of cathodes 104 (including at least one cathode 104 and optional Titanium array 108) are constructed and connected at right angles, and the two right angles are connected with insulating material into a box shape, with cathodes 104 opposite electron sources 102 (such as electron emitters including field emitters and associated gates), forming four walls. In exemplary embodiments, a self-supporting grid is connected to an insulating plane (that is approximately 1 centimeter square in surface area) and is attached to the base of the box. In embodiments where each plane is approximately 1 centimeter square, the total volume of the box is approximately 1 cubic centimeter.

In exemplary embodiments, the pump base is connected to an inside wall of a vacuum system and the sixth open side of the box formed by the ion pump 100 is connected to a chamber having a volume to be pumped. In exemplary implementations, the volume of the chamber is substantially larger than the volume of the ion pump 100. In exemplary embodiments, electrical connections are made from the gate, grid, and cathode via vacuum feed-throughs to the outside of the ion pump 100 package.

In exemplary embodiments, electrons emitted from the electron source 102 are accelerated from the electron source 102 toward the high-voltage grid 106 located near the center of the ion pump 100. The electrons are attracted toward the high-voltage grid 106. In exemplary embodiments, electrons mostly miss the grid wires and pass by the high-voltage grid 106. In exemplary implementations, voltages on the high-voltage grid can be adjusted such that after traveling nearly to the opposite wall of the ion pump 100, the electrons turn and accelerate back toward and through the high-voltage grid again. In exemplary embodiments, this time the electrons collide with another pump wall 112. During this round trip, the electron will ionize gas molecules located within the ion pump 100. In exemplary implementations, gas molecules from a larger chamber to which the pump is open to move into the ion pump 100 and are ionized by electrons.

In exemplary embodiments, both differential ion pumping and triode ion pumping are combined to enhance noble gas pumping. In exemplary embodiments implementing differential ion pumping, a “gate” layer of the field emission walls of the ion pump 100, where the at least one electron source 102 is located, is made of and/or coated with Tantalum (Ta). In exemplary embodiments, a gas ion found between the high-voltage grid 106 and the at least one electron source 102 will be accelerated toward the gate layer where it will collide with the gate layer and be neutralized. In exemplary embodiments, the gas ion sputters Tantalum (Ta) off the gate, which will assist in pumping active gases or burying noble gases, but will not result in permanent pumping of the colliding gas ion. In exemplary implementations, that gas ion will need to be ionized again for another chance at being pumped by one of the following mechanisms. In exemplary implementations, some of the neutralized molecules will bounce off the gate layer with sufficient energy to be trapped in the opposite wall, where they will be buried by subsequently sputtered Tantalum (Ta) and/or Titanium (Ti) and permanently pumped. In exemplary implementations, Tantalum (Ta) is used as the coating on the gate wall due to its high atomic weight, increasing the portion of gas ions that will be bounced back to be pumped on the opposite side.

In exemplary embodiments implementing triode pumping, the pump wall/walls 110 opposite the electron source 102 are grounded, turning the entire pump wall/walls 110 into the at least one cathode 104. Because the voltages are adjusted, configured, and/or arranged such that electrons do not hit the at least one cathode 104, any current measured in the at least one cathode 104 is due to ions. Accordingly, the current measured in the at least one cathode 104 is a measure of the pressure in the ion pump 100. This is an advantage of using the high-voltage grid 106 to accelerate the ions rather than a voltage difference between pump walls (such as the voltage difference between the pump wall/walls 112 with the at least one electron source 102 and the pump wall/walls 110 with the at least one cathode 104). In this way, the at least one cathode 104 functions as a pressure gauge for the ion pump 100. In other implementations, the electron current leaking from emitters to the gate layer would combine with the ion current on that gate layer and would be a large background current from which it would be difficult to extract the very small ion current. In exemplary embodiments, the Titanium array 108 is positioned adjacent to the at least one cathode 104 between the at least one cathode 104 and the high-voltage grid 106. In exemplary implementations, the Titanium array 108 includes periodic protrusions at right angles to the pump wall 110, coated by or made from Titanium (Ti). In exemplary embodiments, ions accelerated toward the at least one cathode 104 and the molecules rebounded from the Tantalum (Ta) gate layer of the electron source 102 are likely to strike the protrusions of the Titanium array 108 at a glancing angle, sputtering off Titanium (Ti) without losing much momentum. In exemplary implementations, the ions will likely continue and be buried in the pump wall 110 near or at the at least one cathode 104. In exemplary implementations, the pump wall 110 is made of stainless steel. In exemplary embodiments, the sputtered Titanium (Ti) will bury previously embedded noble gas molecules in the pump wall 110. Because gases are not buried in the Titanium (Ti) protrusions of the Titanium array 108, Titanium (Ti) sputtering will not release previously buried gases. This will significantly enhance the noble gas pumping.

FIG. 2A is a cross sectional top view diagram of an embodiment of the exemplary ion pump 100, exemplary ion pump 100A. Exemplary ion pump 100A includes at least one electron source 102 positioned at first wall 202 and/or second wall 204 of ion pump 100A, at least one cathode 104 positioned at third wall 206 and/or fourth wall 208 of ion pump 100A, a high-voltage (static potential) grid 106 positioned between the at least one electron source 102 and the at least one cathode 104, and a Titanium array 108 positioned adjacent to the at least one cathode 104 between the at least one cathode 104 and the high-voltage grid 106. Exemplary ion pump 100A operates in a similar fashion to general exemplary ion pump 100 described above. While the area covered by the at least one electron source 102 is shown to cover a certain percentage of first wall 202 and second wall 204, in other embodiments, greater or smaller amounts of first wall 202 and second wall 204 are covered by the at least one electron source 102. While the area covered by the at least one cathode 104 is shown to cover a certain percentage of the third wall 206 and the fourth wall 208, in other embodiments, greater or smaller amounts of third wall 206 and fourth wall 208 are covered by the at least one cathode 104.

FIG. 2B is a cross sectional top view diagram of an embodiment of the exemplary ion pump 100, exemplary ion pump 100B. Exemplary ion pump 100B includes at least one electron source 102 positioned at first wall 202 and/or second wall 204 of ion pump 100B, at least one cathode 104 positioned at third wall 206 and/or fourth wall 208 of ion pump 100B, a high-voltage (static potential) grid 106 positioned between the at least one electron source 102 and the at least one cathode 104, and an optional Titanium array 108 positioned adjacent to the at least one cathode 104 between the at least one cathode 104 and the high-voltage grid 106. Exemplary ion pump 100B operates in a similar fashion to exemplary ion pumps 100 and 100A described above. Exemplary ion pump 100B is different from exemplary ion pump 100A in that the Titanium array 108 is optional. While the area covered by the at least one electron source 102 is shown to cover a certain percentage of first wall 202 and second wall 204, in other embodiments, greater or smaller amounts of first wall 202 and second wall 204 are covered by the at least one electron source 102. While the area covered by the at least one cathode 104 is shown to cover a certain percentage of the third wall 206 and the fourth wall 208, in other embodiments, greater or smaller amounts of third wall 206 and fourth wall 208 are covered by the at least one cathode 104.

FIG. 2C is a cross sectional top view diagram of an embodiment of the exemplary ion pump 100, exemplary ion pump 100C. Exemplary ion pump 100C includes at least one electron source 102 positioned at first wall 202 of ion pump 100C, at least one cathode 104 positioned at third wall 206 of ion pump 100C, a high-voltage (static potential) grid 106 positioned between the at least one electron source 102 and the at least one cathode 104, and an optional Titanium array 108 positioned adjacent to the at least one cathode 104 between the at least one cathode 104 and the high-voltage grid 106. Exemplary ion pump 100C operates in a similar fashion to exemplary ion pumps 100, 100A, and 100B described above. Exemplary ion pump 100C is different from exemplary ion pump 100B in that the at least one electron source 102 is only positioned at first wall 202 of ion pump 100C and the at least one cathode 104 is only positioned at third wall 206 of ion pump 100C. While the area covered by the at least one electron source 102 is shown to cover a certain percentage of the first wall 202, in other embodiments, greater or smaller amounts of the first wall 202 are covered by the at least one electron source 102. While the area covered by the at least one cathode 104 is shown to cover a certain percentage of the third wall 206, in other embodiments, greater or smaller amounts of third wall 206 are covered by the at least one cathode 104.

FIG. 2D is a cross sectional top view diagram of an embodiment of the exemplary ion pump 100, exemplary ion pump 100D. Exemplary ion pump 100D includes at least one electron source 102 positioned at second wall 204 of ion pump 100D, at least one cathode 104 positioned at third wall 206 of ion pump 100D, a high-voltage (static potential) grid 106 positioned between the at least one electron source 102 and the at least one cathode 104, and an optional Titanium array 108 positioned adjacent to the at least one cathode 104 between the at least one cathode 104 and the high-voltage grid 106. Exemplary ion pump 100D operates in a similar fashion to exemplary ion pumps 100, 100A, 100B, and 100C described above. Exemplary ion pump 100D is different from exemplary ion pump 100C in that the at least one electron source 102 is only positioned at second wall 204 of ion pump 100D and the at least one cathode 104 is only positioned at third wall 206 of ion pump 100D. While the area covered by the at least one electron source 102 is shown to cover a certain percentage of the second wall 204, in other embodiments, greater or smaller amounts of second wall 204 are covered by the at least one electron source 102. While the area covered by the at least one cathode 104 is shown to cover a certain percentage of the third wall 206, in other embodiments, greater or smaller amounts of third wall 206 are covered by the at least one cathode 104.

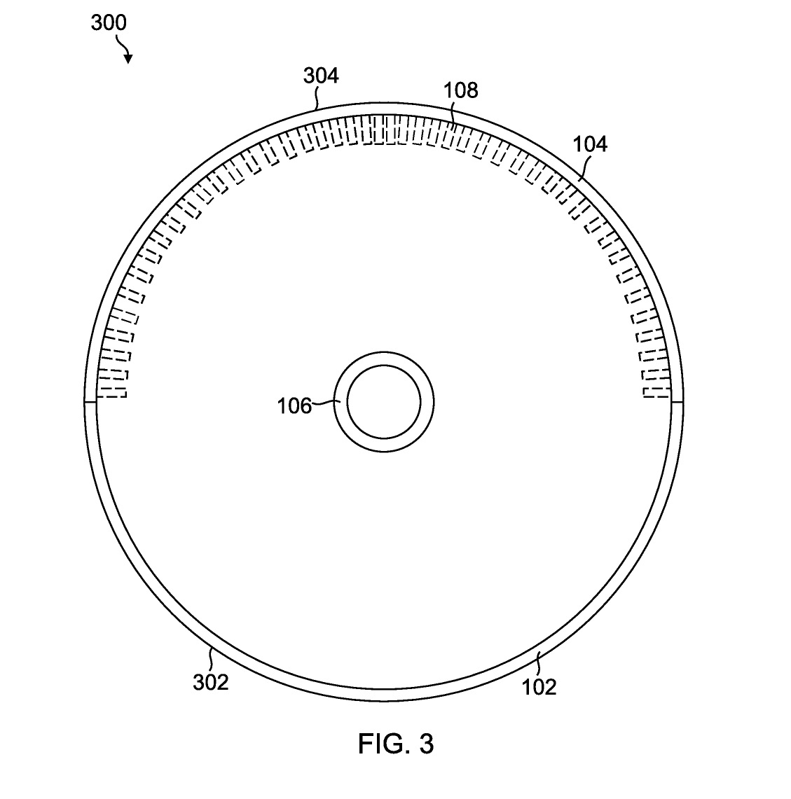

FIG. 3 is a cross sectional top view diagram of an exemplary ion pump 300. Exemplary ion pump 300 is cylindrical in shape and includes at least one electron source 102 positioned at first curved wall 302 of ion pump 300, at least one cathode 104 positioned at second curved wall 304 of ion pump 300, a high-voltage (static potential) grid 106 positioned between the at least one electron source 102 and the at least one cathode 104, and an optional Titanium array 108 positioned adjacent to the at least one cathode 104 between the at least one cathode 104 and the high-voltage grid 106. Exemplary ion pump 300 operates in a similar fashion to exemplary ion pumps 100, 100A, 100B, 100C, and 100D described above. Exemplary ion pump 300 is different from exemplary ion pump 100C in that exemplary ion pump 300 is cylindrical in shape instead of cube-shaped such that at least one electron source 102 is positioned at first curved wall 302 of ion pump 300 and the at least one cathode 104 is positioned at second curved wall 304 of ion pump 300. While the first curved wall 302 and the second curved wall 304 shown in exemplary ion pump 300 take up approximately 50% of the surface of the cylindrical shaped ion pump 300, in other embodiments, the first curved wall 302 and the second curved wall 304 take up different amounts of the surface of the cylindrical shaped ion pump 300.

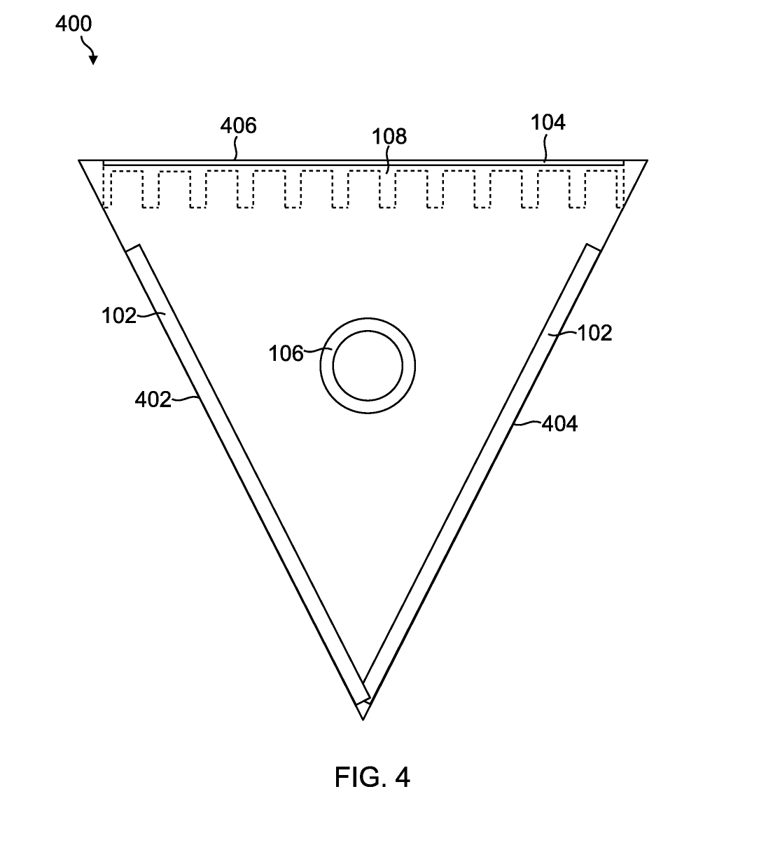

FIG. 4 is a cross sectional top view diagram of an exemplary ion pump 400. Exemplary ion pump 400 is triangular in shape and includes at least one electron source 102 positioned at first wall 402 and/or second wall 404 of exemplary ion pump 400, at least one cathode 104 positioned at third wall 406 of ion pump 400, a high-voltage (static potential) grid 106 positioned between the at least one electron source 102 and the at least one cathode 104, and an optional Titanium array 108 positioned adjacent to the at least one cathode 104 between the at least one cathode 104 and the high-voltage grid 106. Exemplary ion pump 400 operates in a similar fashion to exemplary ion pumps 100, 100A, 100B, 100C, 100D, and 300 described above. Exemplary ion pump 400 is different from exemplary ion pump 100B in that exemplary ion pump 300 is triangular in shape instead of cube-shaped such that at least one electron source 102 is positioned at first wall 402 and/or second wall 404 of ion pump 400 and the at least one cathode 104 is positioned at third wall 406 of ion pump 400. While the area covered by the at least one electron source 102 is shown to cover a certain percentage of the first wall 402 and the second wall 404, in other embodiments, greater or smaller amounts of first wall 402 and second wall 404 are covered by the at least one electron source 102. While the area covered by the at least one cathode 104 is shown to cover a certain percentage of the third wall 406, in other embodiments, greater or smaller amounts of third wall 406 are covered by the at least one cathode 104.

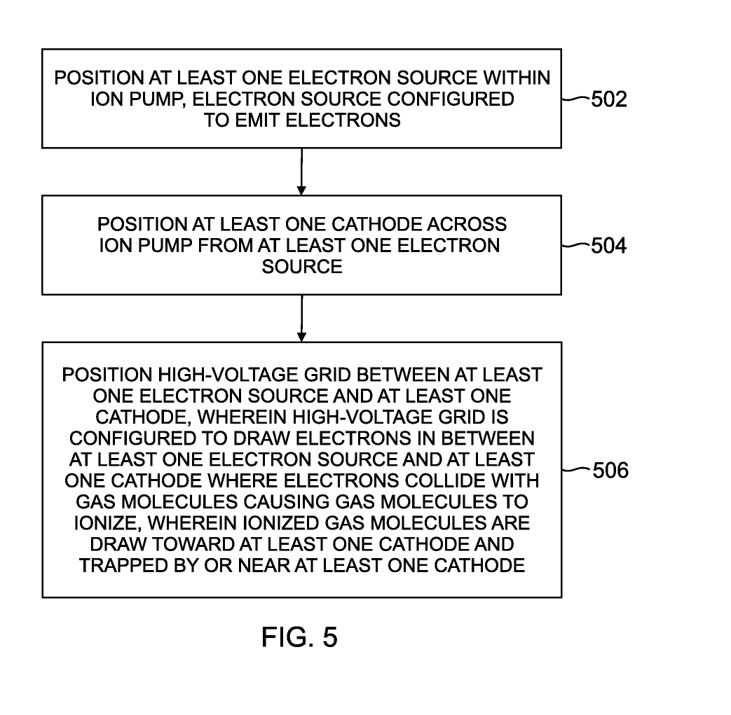

FIG. 5 is a flow diagram of an example method 500 of manufacturing an exemplary ion pump. Exemplary method 500 begins at block 502 with positioning at least one electron source within the ion pump, the electron source configured to emit electrons. Exemplary method 500 proceeds to block 504 with positioning at least one cathode across the ion pump from the at least one electron source. Exemplary method 500 proceeds to block 506 with positioning a high-voltage grid between the at least one electron source and the at least one cathode, wherein the high-voltage grid is configured to draw electrons in between the at least one electron source and the at least one cathode where the electrons collide with gas molecules causing the gas molecules to ionize, wherein ionized gas molecules are drawn toward the at least one cathode and trapped by or near the at least one cathode.

In exemplary embodiments, a processing device is configured to control at least one of the at least one electron source 102, the at least one cathode 104, and the high-voltage grid 106. In exemplary embodiments, the processing device includes or functions with software programs, firmware or other computer readable instructions for carrying out various methods, process tasks, calculations, and control functions, used in the ion pump. These instructions are typically stored on any appropriate computer readable medium used for storage of computer readable instructions or data structures. The computer readable medium can be implemented as any available media that can be accessed by a general purpose or special purpose computer or processor, or any programmable logic device. Suitable processor-readable media may include storage or memory media such as magnetic or optical media. For example, storage or memory media may include conventional hard disks, Compact Disk—Read Only Memory (CD-ROM), volatile or non-volatile media such as Random Access Memory (RAM) (including, but not limited to, Synchronous Dynamic Random Access Memory (SDRAM), Double Data Rate (DDR) RAM, RAMBUS Dynamic RAM (RDRAM), Static RAM (SRAM), etc.), Read Only Memory (ROM), Electrically Erasable Programmable ROM (EEPROM), and flash memory, etc. Suitable processor-readable media may also include transmission media such as electrical, electromagnetic, or digital signals, conveyed via a communication medium such as a network and/or a wireless link.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

### Example Embodiments

Example 1 includes an ion pump comprising: at least one electron source configured to emit electrons into the ion pump; at least one cathode positioned across the ion pump from the at least one electron source; a high-voltage grid positioned between the at least one electron source and the at least one cathode; wherein the high-voltage grid is configured to draw the electrons in between the at least one electron source and the at least one cathode where the electrons collide with gas molecules causing the gas molecules to ionize; and wherein the at least one cathode is configured to draw ionized gas molecules toward the at least one cathode such that the ionized gas molecules are trapped by or near the at least one cathode.

Example 2 includes the ion pump of Example 1, wherein the at least one electron source includes a gate layer; and wherein the gate layer is coated with Tantalum.

Example 3 includes the ion pump of any of Examples 1-2, further comprising a Titanium array positioned between the at least one cathode and the high-voltage grid.

Example 4 includes the ion pump of Example 3, wherein the Titanium array includes periodic protrusions extending away from the at least one cathode; and wherein the periodic protrusions are coated by or made from Titanium.

Example 5 includes the ion pump of Example 4, wherein a first ionized gas molecule of the ionized gas molecules strikes at least a first periodic protrusion of the periodic protrusions causing a first quantity of Titanium to sputter off the first periodic protrusion without causing the first ionized gas molecule to lose much momentum; wherein the first ionized gas molecule is trapped by or near the at least one cathode; and wherein the first quantity of Titanium buries previously embedded ionized gas molecules at or near the at least one cathode.

Example 6 includes the ion pump of Example 5, wherein previously buried ionized gas molecules are not released by the sputtering off of the first quantity of Titanium from the first periodic protrusion because the previously buried ionized gas molecules are not buried in the periodic protrusions.

Example 7 includes the ion pump of any of Examples 1-6, wherein the at least one cathode includes a grounded pump wall positioned across the ion pump from the at least one electron source; and wherein the ionized gas molecules are trapped in the grounded pump wall.

Example 8 includes the ion pump of Example 7, wherein the ionized gas molecules are trapped in the grounded pump wall at least in part by being buried by subsequently sputtered Tantalum or Titanium.

Example 9 includes the ion pump of any of Examples 1-8, wherein the at least one electron source includes a plurality of electron sources; wherein a first portion of the plurality of electron sources are on a first plane; and wherein a second portion of the plurality of electron sources are on a second plane that intersects the first plane.

Example 10 includes the ion pump of Example 9, wherein the second plane is perpendicular to the first plane.

Example 11 includes the ion pump of any of Examples 1-10, wherein the at least one electron source includes at least one of an edge emitter, a sharp tip, a beta emitter, a field emitter; and a thermal electron emitter.

Example 12 includes the ion pump of any of Examples 1-11, wherein the at least one electron source generates sufficient electron current such that enough gas molecules are ionized even without enhancement of a Penning trap.

Example 13 includes the ion pump of any of Examples 1-12, further comprising: wherein the at least one electron source includes: a first plane of electron sources; and a second plane of electron sources connected at a first right angle to the first plane of electron sources; wherein the at least one cathode includes: a third plane of cathodes connected at a second right angle to the second plane of electron sources; and a fourth plane of cathodes connected at a third right angle to the third plane of cathodes; wherein the fourth plane of cathodes is connected at a fourth right angle to the first plane of electron sources such that the first plane of electron sources is opposite the third plane of cathodes, the second plane of electron sources is opposite the fourth plane of cathodes, and the first plane of electron sources, the second plane of electron sources, the third plane of cathodes, and the fourth plane of cathodes form sides of a box shape; and wherein the high-voltage grid is positioned within the box shape.

Example 14 includes the ion pump of any of Examples 1-13, wherein the high-voltage grid is configured to draw the electrons in between the at least one electron source and the at least one cathode by accelerating the electrons from the at least one electron source toward the high-voltage grid.

Example 15 includes the ion pump of any of Examples 1-14, wherein the electrons drawn toward the high-voltage grid mostly miss the grid wires of the high-voltage grid and pass by the high-voltage grid.

Example 16 includes the ion pump of Example 15, wherein voltages on the high-voltage grid are configured such that the electrons that pass by the high-voltage grid turn and accelerate back toward and through the high-voltage grid again causing more of the gas molecules to ionize.

Example 17 includes a method of manufacturing an ion pump comprising: positioning at least one electron source within the ion pump, the at least one electron source configured to emit electrons into the ion pump; positioning at least one cathode across the ion pump from the at least one electron source; positioning a high-voltage grid between the at least one electron source and the at least one cathode; wherein the high-voltage grid is configured to draw the electrons in between the at least one electron source and the at least one cathode where the electrons collide with gas molecules causing the gas molecules to ionize; and wherein the at least one cathode is configured to draw ionized gas molecules toward the at least one cathode such that the ionized gas molecules are trapped by or near the at least one cathode.

Example 18 includes the method of Example 17, further comprising: wherein positioning at least one electron source within the ion pump includes positioning a first electron source on a first plane and positioning a second electron source on a second plane connected at a first right angle to the first plane; wherein positioning at least one cathode across the ion pump from the at least one electron source includes positioning a first cathode on a third plane connected at a second right angle to the second plane and positioning a second cathode on a fourth plane connected at a third right angle to third plane; wherein the fourth plane is connected at a fourth right angle to the first plane such that the first plane is opposite the third plane, the second plane is opposite the fourth plane, and the first plane, second plane, third plane, and fourth plane form sides of a box shape; and wherein positioning a high-voltage grid between the at least one electron source and the at least one cathode includes positioning the high-voltage grid within the box shape.

Example 19 includes the method of any of Examples 17-18, further comprising: positioning a Titanium array between the at least one cathode and the high-voltage grid, the Titanium array having periodic protrusions extending away from the at least one cathode, wherein the periodic protrusions are coated by or made from Titanium; wherein a first ionized gas molecule of the ionized gas molecules strikes at least a first periodic protrusion of the periodic protrusions causing a first quantity of Titanium to sputter off the first periodic protrusion without causing the first ionized gas molecule to lose much momentum; wherein the first ionized gas molecule is trapped by or near the at least one cathode; and wherein the first quantity of Titanium buries previously embedded ionized gas molecules at or near the at least one cathode.

Example 20 includes an ion pump open to a chamber on a first open side and configured to pump a volume of space in the chamber, the ion pump comprising: a first plane including at least a first electron source; a second plane including at least a second electron source, the second plane connected at a first right angle to the first plane; a third plane including at least a first cathode, the third plane connected at a second right angle to the second plane; a fourth plane including at least a second cathode, the fourth plane connected at a third right angle to the third plane; wherein the fourth plane is connected at a fourth right angle to the first plane such that the first plane is opposite the third plane, the second plane is opposite the fourth plane, and the first plane, the second plane, the third plane, and the fourth plane form sides of a box shape; a high-voltage grid positioned within the box shape, wherein the high-voltage grid is configured to draw the electrons in between at least one of the first electron source and the second electron source and at least one of the first cathode and the second cathode where the electrons collide with gas molecules causing the gas molecules to ionize; a Titanium array positioned between the at least one of the first cathode and the second cathode and the high-voltage grid, the Titanium array having periodic protrusions extending away from the at least one of the first cathode and the second cathode, wherein the periodic protrusions are coated by or made from Titanium; wherein the at least one of the first cathode and the second cathode are configured to draw ionized gas molecules toward the at least one cathode such that the ionized gas molecules are trapped by or near the at least one cathode; wherein a first ionized gas molecule of the ionized gas molecules strikes at least a first periodic protrusion of the periodic protrusions causing a first quantity of Titanium to sputter off the first periodic protrusion without causing the first ionized gas molecule to lose much momentum; wherein the first ionized gas molecule is trapped by or near the at least one cathode; and wherein the first quantity of Titanium buries previously embedded ionized gas molecules at or near the at least one cathode.

What is claimed is:

1. An ion pump comprising:
at least one electron source configured to emit electrons into the ion pump;
at least one cathode positioned across the ion pump from the at least one electron source;
a high-voltage grid positioned between the at least one electron source and the at least one cathode;
wherein the high-voltage grid is configured to draw the electrons in between the at least one electron source and the at least one cathode where the electrons collide with gas molecules causing the gas molecules to ionize; and
wherein the at least one cathode is configured to draw ionized gas molecules toward the at least one cathode such that the ionized gas molecules are trapped by or near the at least one cathode.

2. The ion pump of claim 1, wherein the at least one electron source includes a gate layer; and
wherein the gate layer is coated with Tantalum.

3. The ion pump of claim 1, further comprising a Titanium array positioned between the at least one cathode and the high-voltage grid.

4. The ion pump of claim 3, wherein the Titanium array includes periodic protrusions extending away from the at least one cathode; and
wherein the periodic protrusions are coated by or made from Titanium.

5. The ion pump of claim 4, wherein a first ionized gas molecule of the ionized gas molecules strikes at least a first periodic protrusion of the periodic protrusions causing a first quantity of Titanium to sputter off the first periodic protrusion without causing the first ionized gas molecule to lose much momentum;
wherein the first ionized gas molecule is trapped by or near the at least one cathode; and
wherein the first quantity of Titanium buries previously embedded ionized gas molecules at or near the at least one cathode.

6. The ion pump of claim 5, wherein previously buried ionized gas molecules are not released by the sputtering off of the first quantity of Titanium from the first periodic protrusion because the previously buried ionized gas molecules are not buried in the periodic protrusions.

7. The ion pump of claim 1, wherein the at least one cathode includes a grounded pump wall positioned across the ion pump from the at least one electron source; and
wherein the ionized gas molecules are trapped in the grounded pump wall.

8. The ion pump of claim 7, wherein the ionized gas molecules are trapped in the grounded pump wall at least in part by being buried by subsequently sputtered Tantalum or Titanium.

9. The ion pump of claim 1, wherein the at least one electron source includes a plurality of electron sources;
wherein a first portion of the plurality of electron sources are on a first plane; and
wherein a second portion of the plurality of electron sources are on a second plane that intersects the first plane.

10. The ion pump of claim 9, wherein the second plane is perpendicular to the first plane.

11. The ion pump of claim 1, wherein the at least one electron source includes at least one of an edge emitter, a sharp tip, a beta emitter, a field emitter; and a thermal electron emitter.

12. The ion pump of claim 1, wherein the at least one electron source generates sufficient electron current such that enough gas molecules are ionized even without enhancement of a Penning trap.

13. The ion pump of claim 1, further comprising:
wherein the at least one electron source includes:
a first plane of electron sources; and
a second plane of electron sources connected at a first right angle to the first plane of electron sources;
wherein the at least one cathode includes:
a third plane of cathodes connected at a second right angle to the second plane of electron sources; and
a fourth plane of cathodes connected at a third right angle to the third plane of cathodes;
wherein the fourth plane of cathodes is connected at a fourth right angle to the first plane of electron sources such that the first plane of electron sources is opposite the third plane of cathodes, the second plane of electron sources is opposite the fourth plane of cathodes, and the first plane of electron sources, the second plane of electron sources, the third plane of cathodes, and the fourth plane of cathodes form sides of a box shape; and
wherein the high-voltage grid is positioned within the box shape.

14. The ion pump of claim 1, wherein the high-voltage grid is configured to draw the electrons in between the at least one electron source and the at least one cathode by accelerating the electrons from the at least one electron source toward the high-voltage grid.

15. The ion pump of claim 1, wherein the electrons drawn toward the high-voltage grid mostly miss the grid wires of the high-voltage grid and pass by the high-voltage grid.

16. The ion pump of claim 15, wherein voltages on the high-voltage grid are configured such that the electrons that pass by the high-voltage grid turn and accelerate back toward and through the high-voltage grid again causing more of the gas molecules to ionize.

17. A method of manufacturing an ion pump comprising:
positioning at least one electron source within the ion pump, the at least one electron source configured to emit electrons into the ion pump;
positioning at least one cathode across the ion pump from the at least one electron source;
positioning a high-voltage grid between the at least one electron source and the at least one cathode;
wherein the high-voltage grid is configured to draw the electrons in between the at least one electron source and the at least one cathode where the electrons collide with gas molecules causing the gas molecules to ionize; and
wherein the at least one cathode is configured to draw ionized gas molecules toward the at least one cathode such that the ionized gas molecules are trapped by or near the at least one cathode.

18. The method of claim 17, further comprising:
wherein positioning at least one electron source within the ion pump includes positioning a first electron source on a first plane and positioning a second electron source on a second plane connected at a first right angle to the first plane;
wherein positioning at least one cathode across the ion pump from the at least one electron source includes positioning a first cathode on a third plane connected at a second right angle to the second plane and positioning a second cathode on a fourth plane connected at a third right angle to third plane;
wherein the fourth plane is connected at a fourth right angle to the first plane such that the first plane is opposite the third plane, the second plane is opposite the fourth plane, and the first plane, second plane, third plane, and fourth plane form sides of a box shape; and
wherein positioning a high-voltage grid between the at least one electron source and the at least one cathode includes positioning the high-voltage grid within the box shape.

19. The method of claim 17, further comprising:
positioning a Titanium array between the at least one cathode and the high-voltage grid, the Titanium array having periodic protrusions extending away from the at least one cathode, wherein the periodic protrusions are coated by or made from Titanium;
wherein a first ionized gas molecule of the ionized gas molecules strikes at least a first periodic protrusion of the periodic protrusions causing a first quantity of Titanium to sputter off the first periodic protrusion without causing the first ionized gas molecule to lose much momentum;
wherein the first ionized gas molecule is trapped by or near the at least one cathode; and
wherein the first quantity of Titanium buries previously embedded ionized gas molecules at or near the at least one cathode.

20. An ion pump open to a chamber on a first open side and configured to pump a volume of space in the chamber, the ion pump comprising:
a first plane including at least a first electron source;
a second plane including at least a second electron source, the second plane connected at a first right angle to the first plane;
a third plane including at least a first cathode, the third plane connected at a second right angle to the second plane;
a fourth plane including at least a second cathode, the fourth plane connected at a third right angle to the third plane;
wherein the fourth plane is connected at a fourth right angle to the first plane such that the first plane is opposite the third plane, the second plane is opposite the fourth plane, and the first plane, the second plane, the third plane, and the fourth plane form sides of a box shape;
a high-voltage grid positioned within the box shape, wherein the high-voltage grid is configured to draw the electrons in between at least one of the first electron source and the second electron source and at least one of the first cathode and the second cathode where the electrons collide with gas molecules causing the gas molecules to ionize;
a Titanium array positioned between the at least one of the first cathode and the second cathode and the high-voltage grid, the Titanium array having periodic protrusions extending away from the at least one of the first cathode and the second cathode, wherein the periodic protrusions are coated by or made from Titanium;
wherein the at least one of the first cathode and the second cathode are configured to draw ionized gas molecules toward the at least one cathode such that the ionized gas molecules are trapped by or near the at least one cathode;
wherein a first ionized gas molecule of the ionized gas molecules strikes at least a first periodic protrusion of the periodic protrusions causing a first quantity of Titanium to sputter off the first periodic protrusion without causing the first ionized gas molecule to lose much momentum;
wherein the first ionized gas molecule is trapped by or near the at least one cathode; and
wherein the first quantity of Titanium buries previously embedded ionized gas molecules at or near the at least one cathode.
